(19) United States
(12) Patent Application Publication
(10) Pub. No.: US 2004/0093432 A1
(43) Pub. Date: May 13, 2004

(54) Method and system for conducting image processing from a mobile client device

(75) Inventors: Jiebo Luo, Pittsford, NY (US); Amit Singhal, Scottsville, NY (US); Robert T. Gray, Rochester, NY (US); Nicolas P. Touchard, Suresnes (FR)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/289,938

(22) Filed: Nov. 7, 2002

(51) Int. Cl. G06F 15/16

(52) U.S. Cl. 709/247

(57) ABSTRACT

An image processing system includes a client device including a limited display having a resolution less than VGA and a bit depth less than 24 bits for displaying a low resolution digital image and image processing operation indicators, an operator interface for user input, a CPU and a memory, the CPU being capable of running a limited client image processing program, and a first communication port; an image processing server for performing an image processing operation on a high definition image stored at the image processing server, for producing a low resolution version of the image for display on the limited display of the client device, and for producing image processing operation indicators indicating a particular image processing operation, the image processing server including a second communication port and being responsive to remote user inputs to produce a processed digital image; and a limited bandwidth mobile communication network connectable with the first and second communication ports for transmitting the low resolution image and the image processing operation indicators from the image processing server to the client device and transmitting remote user inputs from the client device to the image processing server.

### FIELD OF THE INVENTION

The present invention is related to image processing, and in particular to the use of a mobile client device with limited display and computing capabilities to conduct the image processing.

### BACKGROUND OF THE INVENTION

The advances in mobile devices such as PDAs (e.g., Palm and Pocket PCs) and cell phones usher in a variety of new mobile computing applications. Given today's hectic lifestyle, people are increasingly attracted to the appeal and benefit of mobile computing - accessing and manipulating your data from anywhere at anytime. From the early killer applications of address book and schedule keeping, mobile computing is rapidly moving into territories unimaginable just a couple of years ago. While laptop computers are becoming closer matches to their desktop counterparts in computing power, their size, weight and power consumption are still a great hindrance to mobile computing not everyone is willing to carry a laptop around. The computing power of PDAs has reached a point that can enable people to start thinking about more computationally intensive mobile computing tasks such as image processing.

Image processing typically involves high-performance image processing on high definition images. It is, by far, among the most computationally intensive tasks in terms of CPU and memory, even for the most powerful desktop computer systems. A high definition image has at least 1 million pixels. A 1-mega pixel color digital image takes 3 mega bytes to store in the uncompressed format needed for image processing. Counting the intermediate results typically needed to be stored in memory for subsequent processing, the amount of memory and the kind of CPU needed to process such a large amount of data becomes enormous.

The PDAs of today have very limited computing power, limited memory, and limited display capabilities. The CPU is not capable of handling intensive computation, and the total memory on board is typically between 1 MB to 32 MB. In addition, PDAs have very limited display capabilities, both in terms of screen size and color bit depth. At the low end, a Palm 100 can only display 100×100×1 bit (two colors), and at high end, a SONY Clie can display 320×240×16 bit (64,000 colors), albeit for a very high price that may rival a middle-of the-line laptop. Cellular phones are even more limited in terms of computation power and memory.

The solution to the computing power problem seems to lie in wireless communication, where a server with enormous CPU power and massive memory and storage can perform the heavy-duty part of the mobile computing. A client such as a PDA or a cell phone can get away with performing a minimum portion of the overall computing if it is connected to the server through wireless links. The mobility is preserved and in some aspect improved over using a laptop computer. At the same time, a mobile device user can take advantage of image processing software residing on a server in order to obtain a high quality print from an image that has been subjected to high accuracy and high definition image processing using dedicated expensive hardware and software in the laboratory. Furthermore, a certain level of user input or feedback can be obtained via interaction through a mobile device and transmitted to the server to correct errors made by the software on the server, guaranteeing satisfactory results from image processing.

Home printing has also been a challenge due to the limitations on computing hardware and software at home and consumer know-how. After requesting and previewing image processing on a mobile device, high quality prints from the high definition images can be ordered via the mobile device and printed by high-quality, high-throughput printers networked to the image processing server. The prints can be mailed to the user afterwards.

However, due to limited bandwidth of wireless links associated with mobile devices, as well as the cost for airtime during transmission of information between the server and the client, significant effort needs to be devoted to minimizing the amount of such traffic of information (or the amount of communicated information).

Conventional systems for client-server image processing use wired communication links such as the Internet. US Patent Application 20020019859 by Watanabe, published Feb. 14, 2002, describes a method and system for contents data processing service that transfers contents data from a terminal of an orderer to a processing apparatus of an order receiver via a communication line, processes the transferred contents data in the processing apparatus of the order receiver and transfers processed contents data from the processing apparatus of the order receiver to the terminal of the orderer via the communication line and/or stores and manages the processed contents data in a storage area of a data managing unit that is accessible from at least one of the terminal of the orderer and a terminal of a third party via the communication line. Said contents data is digital image data, said processing performed in said processing apparatus of the order receiver is high definition image processing, and said processed contents data is digital image data that has been subjected to image processing. Said high definition image processing includes at least one of red-eye correction processing, defect erasing processing, dodging processing, lens aberration correction processing, fading correction processing, granulation restraining processing, sharpening processing, gradation correction processing, back light correction processing, RP style finish processing, cloth filter finish processing, soft focus finish processing, monotone finish processing, slender body finish processing, fair complexion finish processing, and under/over correction processing. This system can take advantage of server image processing engines for computers at homes linked to the Internet. However, this system cannot be used for mobile image processing. With this system, all the image processing happens on the server, and there are no limitations in bandwidth and display.

There is, therefore, a need to provide a mobile image processing system that is capable of: (1) minimizing computational load on a mobile device; (2) maximizing the benefit of user feedback from limited input means of a mobile device; (3) minimizing the amount of information needed to be transmitted between the server and a mobile device; and (4) optimizing the rendering of the result of image processing for display on a mobile device.

### SUMMARY OF THE INVENTION

The need is met by the present invention by providing an image processing system that includes a client device including a limited display having a resolution less than VGA and a bit depth less than 24 bits for displaying a low resolution digital image and image processing operation indicators, an operator interface for user input, a CPU and a memory, the CPU being capable of running a limited client image processing program, and a first communication port ; an image processing server for performing an image processing operation on a high definition image stored at the image processing server, for producing a low resolution version of the image for display on the limited display of the client device, and for producing image processing operation indicators indicating a particular image processing operation, the image processing server including a second communication port and being responsive to remote user inputs to produce a processed digital image; and a limited bandwidth mobile communication network connectable with the first and second communication ports for transmitting the low resolution image and the image processing operation indicators from the image processing server to the client device and transmitting remote user inputs from the client device to the image processing server. ADVANTAGES OF THE INVENTION

The present invention provides a system that is capable of mobile image processing by: (1) minimizing computational load on a mobile device; (2) maximizing the benefit of user feedback from limited input means of a mobile device; (3) minimizing the amount of information needed to be transmitted between the server and a mobile device; and (4) optimizing the rendering of the result of image processing for display on a mobile device.

### BRIEF DESCRIPTION OF THE DRAWINGS

FIG. 1 is a schematic view showing a preferred embodiment of the present invention;

FIG. 2 is a figurative view of an example of a GUI of a mobile device for selecting an image processing operation of the present invention;

FIG. 3 is a figurative view of an example of a GUI of a mobile device for previewing an image processing operation of the present invention;

FIG. 4 is a figurative view of an example of a GUI of a mobile device for previewing redeye correction of the present invention; and

FIG. 5 is a flow chart showing the steps of the method of the present invention.

### DESCRIPTION OF THE PREFERRED EMBODIMENT

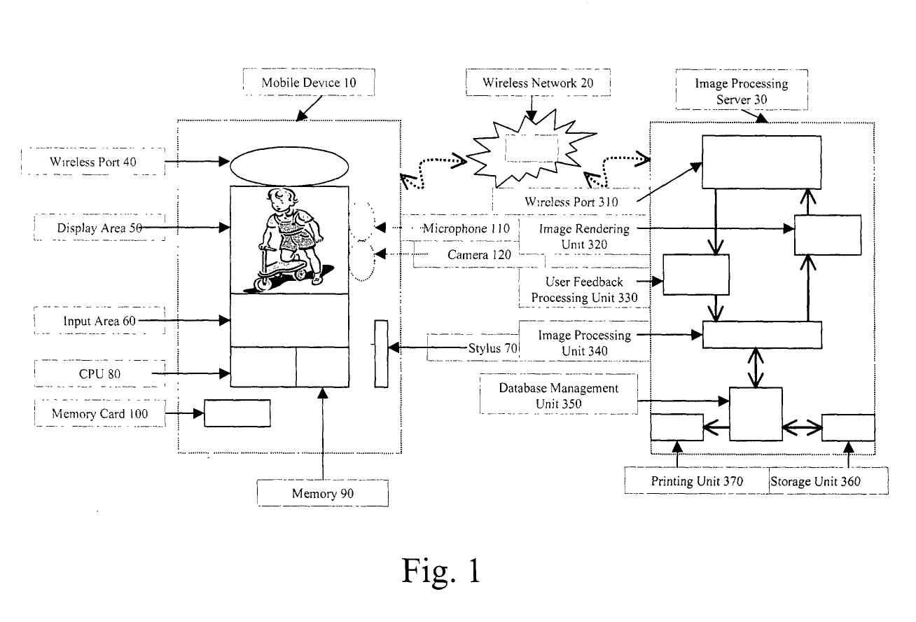

Referring to FIG. 1, there is shown a complete end-to-end mobile image processing system according to a preferred embodiment of the present invention. This system includes a mobile device 10, a wireless communication network 20, and an image processing server 30. A typical mobile device 10 can include a wireless communication port 40 for transmitting and receiving information, a display 50, an operator interface 60 (for example a touch screen, a keypad or a stylus 70) for collecting user input, a CPU 80 for running a limited client image processing program, a memory 90 for storing programs (including the client image processing program) and intermediate data, a memory card 100 for expanded memory and data storage, a microphone 110 for voice acquisition and a digital camera 120 for capturing images.

A mobile device does not necessarily include all of the above components (for example, a particular cell phone might not have a touch screen input area or a particular PDA might not have a microphone). In general, a mobile device that fits the above definitions can be a PDA with wireless capability, a cellular phone, a cellular phone with a digital camera, a hybrid PDA/cellular phone combination, or a digital camera with wireless capability.

Still referring to FIG. 1, the image processing server 30 is shown in more detail. A typical image processing server 30 consists of a wireless communication port 310 for transmitting and receiving data, an image rendering unit 320 for preparing images for optimal display on the limited display of a mobile device, a user feedback processing unit 330 for interpreting user feedback and sending control signals to other units, an image processing unit 340 for performing image processing on high definition images, a database management unit 350 for managing the high definition images stored in a storage unit 360. In addition, the image processing server may also contain a printing unit 370 for fulfilling user request of making high quality prints out of either processed or unprocessed high definition images. The phrases “high definition” and “high resolution” can be used interchangeably.

Still referring to FIG. 1, a limited bandwidth wireless communication network 20 connects the communication port of the mobile device 10 to that of the image processing server 30. The entire network may be the commercial wireless network for cellular telephones or it may also include the Internet for relaying information.

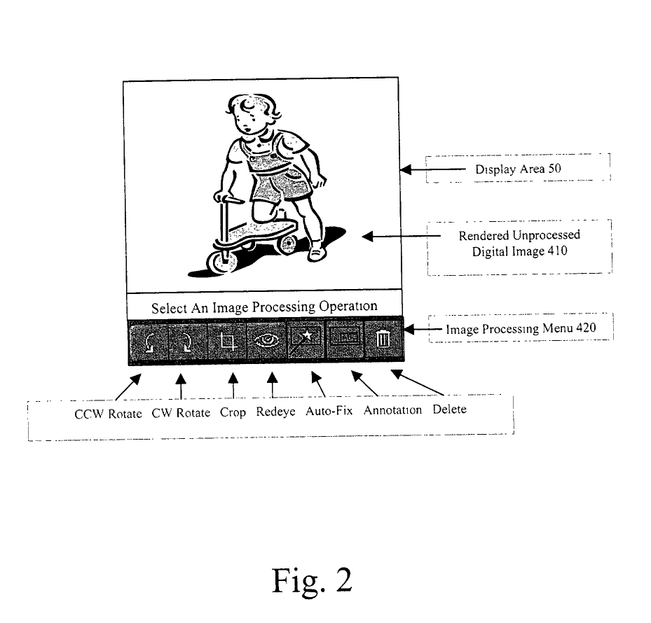

An image processing operation can be initiated by a user request from a mobile device 10. Referring to FIG. 2, there is shown a figurative view of an example of a GUI (graphical user interface) of a mobile device for selecting an image processing operation of the present invention. A resized, rendered but unprocessed digital image 410 is received and displayed in the display area 50 of the mobile device 10. At the same time, an image processing menu 420 is presented to the user. Typically, the menu contains image processing operations such as redeye reduction, image rotation, image cropping, auto fix, text/voice annotation, and image deleting, as shown by the icons at the bottom of the display area in FIG. 2. Auto fix refers to, collectively, brightness adjustment, color adjustment, and contrast adjustment, as in many image processing software packages (e.g., Adobe Photoshop, Microsoft Picture It!). A user can use a stylus 70 to select an icon representing an image processing operation, or speak into a microphone 110 a word corresponding to an icon and the image processing operation it represents, or use the keypad (input area 60) to select the corresponding image processing operation. For example, a user can request that redeye reduction be performed by selecting the corresponding icon. Furthermore, the user input may include an indication of the general region of the image where the redeye reduction needs to be performed. The request for the selected image processing operation is then sent to the image processing server 30. High definition images are then processed by the requested image processing operation by the image processing unit 340.

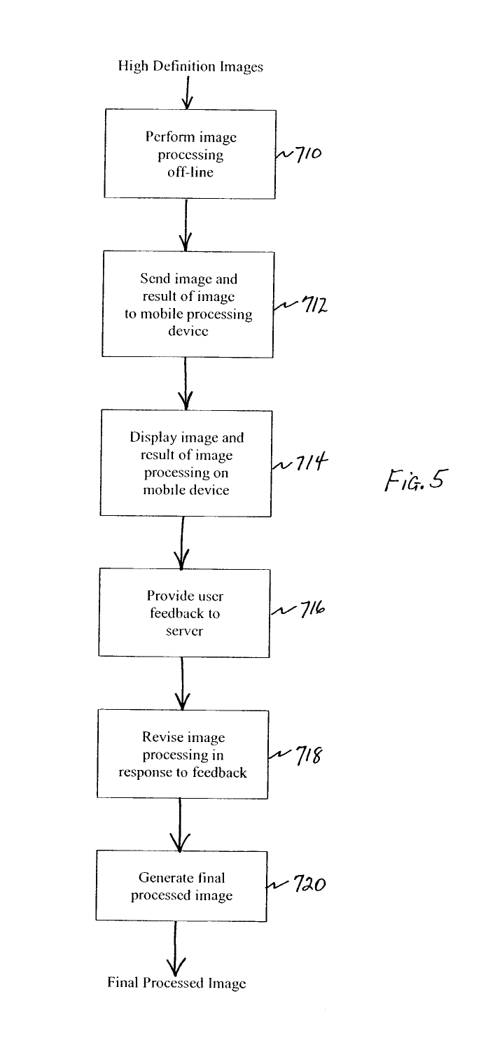

Referring to FIG. 5, the steps of mobile image processing are shown for a preferred embodiment of the present invention. Assuming that high definition images have been uploaded to the image processing server 30, the image processing unit 340 first performs 710 image processing on all the high definition images off-line. At the request of a mobile device 10, the image processing server 30 sends 712 the image, the result of image processing (after proper resizing and rendering), and an image processing operation indicator to the mobile device. The mobile device then displays 714 the image and the result of image processing. Next, a user provides feedback 716 regarding the result of image processing and the mobile device sends user feedback inputs to the image processing server. Finally, the image processing server 30 revises the image processing 718 in response to the user feedback and generates 720 a final processed high definition image.

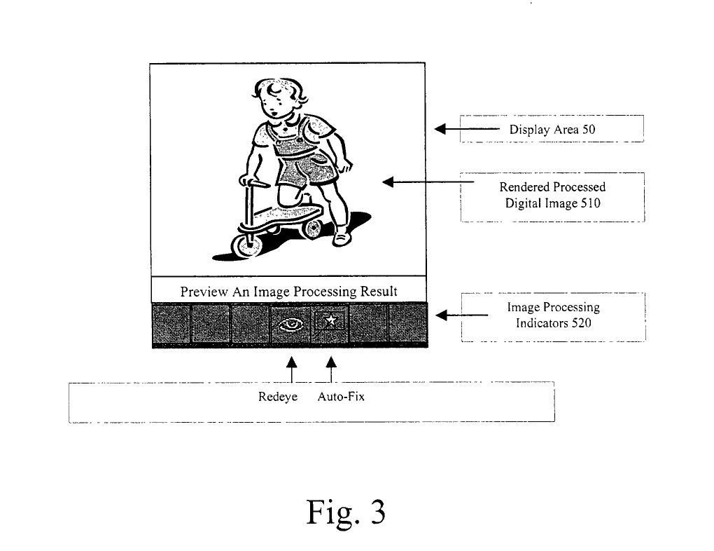

Typically, the default image processing operations performed by default on the image processing server may include redeye reduction, automatic image cropping, and auto fix. Again, auto fix refers to brightness adjustment, color adjustment, and contrast adjustment, collectively. Referring now to FIG. 3, there is shown a figurative view of an example of a GUI of a mobile device for previewing the result of an image processing operation of the present invention.

Information about the types of image processing operation performed on a high definition image, in the form of an image processing operation indicator, is sent to the client mobile device 10 upon a request for previewing an image, along with a rendered and resized version of the unprocessed high definition digital image.

The version of the unprocessed image 410 is displayed in the display area 50 of the mobile device 10, with image processing indicators 520, in the form of icons, indicating the availability of the result of the automatically performed image processing operation. The user can select what image processing result to preview by using a stylus 70 to tap on an icon corresponding to the image processing operation indicator, or by speaking into a microphone 110 a word corresponding to an icon representing an image processing operation, or using the keypad (input area 60) to select the icon. If an image processing result is requested by a user, a resized, rendered version of the processed high definition digital image 510 is transmitted and displayed in the display 50 of the mobile device 10. Note that an image processing operation does not necessarily always have any effect, i.e. generating a new image. For example, redeye correction would have no effect on an image if no red eyes are present or detected. Only if the result of the image processing is different from the original, a corresponding icon will be shown.

Also the effect of image processing operation may not show on the mobile device limited display, therefore rendering may be performed to boost image change perception on the target display: increased contrast, stretched color balance, increased magnification, and so on.

One particularly valuable image processing operation is redeye reduction. U.S. Pat. No. 6,292,574 issued Sep. 18, 2001 to Schildkraut et al., describes a computer program product for detecting eye color defects of a subject in an image due to flash illumination comprises: a computer readable storage medium having a computer program stored thereon for performing the steps of detecting skin colored regions in a digital image; searching the skin colored regions for groups of pixels with color characteristic of redeye defect; and correcting color of the pixels based on a location of redeye defect found. Such a computer program is computationally intensive and should only be run on an image processing server with high computing power and large memory. However, the automatic redeye reduction program can make mistakes, including false alarms (e.g., red light bulbs on a Christmas tree) and misses (e.g., missing objectionable red eyes). Therefore, there is a need for user previewing in order to reject or correct such mistakes.

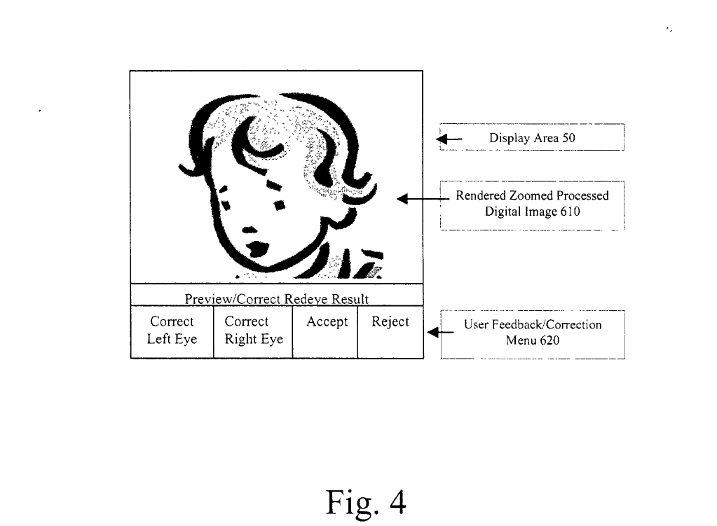

FIG. 4 is a figurative view of an example of a GUI of a mobile device for previewing redeye reduction of the present invention. Because redeye is localized in a human face, it makes sense to only display an area around the face that has red eyes. Therefore, upon the user request for previewing, a zoomed-in or magnified area of the processed digital image is rendered by the image processing server 30 and sent to the mobile device 10. This zoomed processed image 610 is presented to the user in the display area 50 of the mobile device. At the same time, a user feedback/correction menu 620 is also presented. A user can choose to “reject” a false alarm correction, or “accept” a satisfactory correction, or even “correct” the location of “left eye” or “right eye”. If a correction action is selected, a cross-hair is shown to indicate the automatically determined redeye location and a user can use the stylus 70 or the keypad (input area 60) to move the cross-hair in order to revise the redeye location.

The function of the image processing program on the client device can be limited to what is minimally needed for the main purpose of facilitating user input and feedback. Typically, a client image processing program should be capable of displaying a low-resolution image (which may have been rendered in advance on the image processing server), rotating a low-resolution image, indicating user feedback (e.g., indicating which icon is selected by user input, adding a cross-hair for user correction of redeye location), etc. For more capable client devices, part of the image rendering operations, e.g., color quantization and error diffusion, can be shifted from the image processing server 30 to the mobile device 10.

Although this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

### Parts List

10 mobile device

20 wireless network

30 image processing server

40 client wireless communication port

50 display

60 operator interface

70 stylus

80 CPU

90 memory

100 memory card

110 microphone

120 digital camera

310 server wireless communication port

320 image rendering unit

330 user feedback processing unit

340 image processing unit

350 database management unit

360 storage unit

370 printing unit

410 rendered unprocessed digital image

420 image processing menu

510 rendered processed digital image

520 image processing indicators

610 rendered zoomed processed digital image

620 user feedback/correction menu

710 perform image processing step

712 send image step

714 display image step

716 provide user feedback step

718 revise image processing step

720 generate final image step

What is claimed is:

1. An image processing system comprising:
(a) a client device including a limited display having a resolution less than VGA and a bit depth less than 24 bits for displaying a low resolution digital image and image processing operation indicators, an operator interface for user input, a CPU and a memory, the CPU being capable of running a limited client image processing program, and a first communication port;
(b) an image processing server for performing an image processing operation on a high definition image stored at the image processing server, for producing a low resolution version of the image for display on the limited display of the client device, and for producing image processing operation indicators indicating a particular image processing operation, the image processing server including a second communication port and being responsive to remote user inputs to produce a processed digital image; and
(c) a limited bandwidth mobile communication network connectable with the first and second communication ports for transmitting the low resolution image and the image processing operation indicators from the image processing server to the client device and transmitting remote user inputs from the client device to the image processing server.

2. The system claimed in claim 1, wherein the limited bandwidth mobile communication network is a commercial wireless network used by cellular telephones.

3. The system claimed in claim 2, wherein the wireless communication network includes the Internet.

4. The system claimed in claim 1, wherein the image processing server further comprises a digital image storage unit and a database management unit.

5. The system claimed in claim 1, wherein the image processing server further comprises a user input processing unit responsive to the remote user inputs for controlling the host image processing application.

6. The system claimed in claim 1, wherein the image processing server includes an image processing unit for performing the image processing operation and an image rendering unit for generating the low resolution version of the image.

7. The system claimed in claim 1, wherein the operator interface of the client device comprises a touch-screen.

8. The system claimed in claim 1, wherein the operator interface of the client device comprises microphone and a speech recognition unit.

9. The system claimed in claim 1, wherein the operator interface of the client device comprises a keypad with buttons.

10. The system claimed in claim 1, wherein the client device comprises a digital camera and a docking station.

11. The system claimed in claim 1, wherein the client device comprises a cellular telephone.

12. The system claimed in claim 11, wherein the cellular telephone further comprises a low resolution digital camera.

13. The system claimed in claim 1, wherein the client device comprises a PDA.

14. The system claimed in claim 13, wherein the PDA further comprises a digital camera.

15. The system claimed in claim 1, wherein the client device comprises a hybrid cell phone/PDA.

16. The system claimed in claim 1, wherein the image processing server performs the image processing operation prior to a remote user input and sends the low resolution image and image processing operation indicators to the client device.

17. The system claimed in claim 1, wherein the image processing server sends the low resolution image to the client device prior to image processing and wherein the operator interface of the client device includes a menu of image processing operations.

18. The system claimed in claim 1, wherein the resolution of the display of the client device is insufficient for displaying the effect of the image processing operation.

19. The system claimed in claim 18, wherein the image processing operation is red eye reduction and the image processing operation indicators include an indication that redeye reduction was performed.

20. The system claimed in claim 19, wherein the image processing server is responsive to a user input to provide an indication of the location in the image where the redeye reduction was performed.

21. The system claimed in claim 20, wherein the indication of the location is provided by sending an enlarged portion of the image where redeye reduction was performed, with a graphic element in the image indicating the location of redeye reduction.

22. The system claimed in claim 18, wherein the image processing operation is redeye reduction that is performed in response to an initial user input requesting that redeye reduction be performed.

23. The system claimed in claim 22, wherein the user input includes an indication of the region of the image where the redeye reduction is to be performed.

24. The system claimed in claim 1, wherein the limited client image processing application includes an application for displaying the low resolution image and the image processing operation indicators on the display.

25. The system claimed in claim 24, wherein the limited client image processing application further includes rotating the low resolution digital image in response to user input.

26. The system claimed in claim 1, wherein the image processing operation includes one or more of the operations of redeye reduction, image cropping, image re-orientation, and auto fix.

27. The system claimed in claim 1, wherein the image processing operation indicator is an icon.

28. The system claimed in claim 27, wherein the icon can be selected to pre-view the result of the image processing operation on the display of the client device.

29. The system claimed in claim 28, wherein the icon can be selected via the operator interface to generate a user input signal.

30. The system claimed in claim 20, wherein the user can revise the redeye location via the operator interface.

31. A method of conducting image processing from a client device having a limited display and limited image processing power, comprising the steps of:
(a) providing a client device including a limited display having a resolution less than VGA and a bit depth less than 24 bits for displaying a low resolution digital image and image processing operation indicators, an operator interface for user input, a CPU and a memory, the CPU being capable of running a limited client image processing application, and a first communication port;
(b) providing an image processing server for performing an image processing operation on a high resolution image stored at the image processing server, for producing a low resolution version of the image for display on the limited display of the client device, and for producing image processing operation indicators indicating a particular image processing operation, the image processing server including a second communication port and being responsive to remote user inputs to produce a processed digital image;
(c) producing a low resolution version of the image, a processed high resolution digital image, and a low-resolution preview image representing the effect of the image processing operation in the image processing server;
(d) transmitting the low resolution version of the image along with image processing operation indicators to the client device over a limited bandwidth mobile communication network and displaying the low resolution version of the image and the image processing operation indicators on the client device;
(e) using the displayed image processing operation indicators and the operator interface to request a preview image and transmitting the preview image to the client device;
(f) displaying the preview image on the display of the client device;
(g) using the operator interface to obtain user feedback and transmitting the user feedback to the client device; and
(h) producing a final processed high resolution image on the image processing server in response to the user feedback.

32. The method claimed in claim 31, wherein the image processing operation is redeye reduction and the preview image is an enlarged portion of the image where redeye reduction was performed, with a graphic element in the image indicating the location of redeye reduction.

33. The method claimed in claim 31, wherein the user input includes an indication of a correction to the region of the image where the redeye reduction should be performed.

34. The method claimed in claim 31, wherein the image processing operation is auto fix (color, brightness, and contrast adjustment) and the preview image is a low resolution version of the auto fixed image.
